(19) United States
(12) Patent Application Publication
(10) Pub. No.: US 2006/0244762 A1
(43) Pub. Date: Nov. 2, 2006

(54) IMAGE EDITING METHOD

(75) Inventor: Kazuaki OHSHIMA, Atsugi-shi, Kanagawa-ken (JP)

Correspondence Address: FISH & RICHARDSON P.C., P.O. BOX 1022, MINNEAPOLIS, MN, 55440-1022, US

(73) Assignee: SEMICONDUCTOR ENERGY LABORATORY CO., LTD., Atsugi-shi (JP)

(21) Appl. No.: 11/279,737

(22) Filed: Apr. 13, 2006

(30) Foreign Application Priority Data
Apr. 28, 2005 (JP) 2005-133386

(51) Int. Cl. G09G 5/00

(52) U.S. Cl. 345/619

(57) ABSTRACT

The present invention solves a problem that an operation to input or select an address of an image which is to be synthesized or a name of a part whenever an image included in another folder is synthesized to a screen or an image which is being edited. An image editing method, using a computer including a memory portion and a display portion connected to the computer, includes the steps of reading first image data from the memory portion to display as a first image in an image editing window displayed in the display portion; displaying second image data which is synthesized to the first image as an icon in the image editing window; and displaying the icon as a second image after the icon is selected by an icon selecting means in the image editing window to synthesize the first and second images.

### BACKGROUND OF THE INVENTION

1. Field of the Invention

The present invention relates to an information processing device by which an object such as a two dimensional figure existing in a screen is iconified to be displayed, and an image editing method. Specifically, the present invention relates to an information processing device which can be utilized simply and certainly by iconifying a part which is to be synthesized with a shape of the part itself and displaying it as an icon, and an image editing method, in computer aided design (CAD)

Note that, in the present specification and the present invention, iconification means that an image used for editing is displayed in a window for editing an image (image editing window) as a reduced image; a deformed image; or a symbolized image. Also, in the present invention, icon means a figure displayed in a window for editing an image as a reduced image; a deformed image; or a symbolized image. An image used for editing is displayed in the window by selecting the icon by using a mouse or the like.

2. Description of the Related Art

In recent years, an image editing using a computer has been actively performed. Especially, a CAD system is widely utilized because a design of a figure or a design of various drawings can be easily created and used (For example, Patent Document 1).

FIG. 4 shows a display housing 401, a computer 402, a keyboard 403, and a mouse 404. The computer 402 is connected to the display housing 401, the mouse 404 and the keyboard 403. The display housing 401 includes a display portion 405, in which an image editing window (work area) 406, a mouse cursor 407, a two dimensional figure (object) 408, and a toolbar 409 are displayed. Also, a memory portion 410 for storing image information or the like is included inside the computer.

FIGS. 5A to 5D sequentially describe a method for synthesizing a screen or an image (first image) which is being edited and an image included in another folder (second image) in the image editing window 406 of the display portion 405 in FIG. 4. FIGS. 5A to 5D show an image editing window 501, a mouse cursor 502, a two dimensional figure (first image) 503, and a toolbar 504.

Hereinafter, a method for synthesizing an image which is being edited and an image included in another folder in the image editing window will be described with reference to FIGS. 5A to 5D.

First, in FIG. 5A, in a case of synthesizing an image in the image editing window which is being edited and an image included in another folder, the toolbar 504 is selected using the keyboard 403 or the mouse 404. In the selected toolbar, a command for synthesizing or reading the image is selected.

Subsequently, in FIG. 5B, an address or a name of an image which is to be synthesized is inputted to or selected by using an anew displayed sub-window 505 which selects an image which is to be synthesized, by using the keyboard 403 or the mouse 404.

Subsequently, in FIG. 5C, an image which is to be synthesized is displayed. The image to be synthesized is selected by using the mouse cursor 502, as for the image which is to be synthesized, and moved to a random position in the image editing window in which the first image is displayed, by using the mouse cursor 502. Consequently, the synthesis of the first image and the second image is completed, as shown in FIG. 5D.

FIG. 6 shows a conventional flow chart at the time of synthesizing an image. A computer reads image data of a first image from a memory portion in a step S601 in FIG. 6 (FIG. 5A). A file name of image data of a second image is inputted, or a folder is selected in a displayed sub-window in a step S602 in FIG. 6 (FIG. 5B). The second image is displayed in an image editing window in a step S603 in FIG. 6. Thereafter, the image is moved to a random position by operating a mouse pointer which is displayed in a display portion by using a mouse or the like in a step S604 in FIG. 6 (FIG. 5C). Consequently, the edit of the image is completed (FIG. 5D).

[Patent Document] Japanese Patent Laid-Open No. 2003-91562

However, it is troublesome to select the toolbar 504 and input or select an address or a name of a part of image data which is to be synthesized in the anew displayed sub-window 505, by using the keyboard 403 or the mouse 404, every time an image which is being edited and an image included in another folder are synthesized (FIG. 6). Also, it is extremely inefficient to carry out a method by which an image which is to be synthesized is selected and dropped at a random position by using the mouse cursor 502 to synthesized, every time images are synthesized.

By a conventional image editing method, an image included in another folder is displayed with a name of a place where the image is saved or a name of the image, and a shape of the image cannot be judged; therefore, operating efficiency is bad, and also, mistakes during an operation easily occur.

As described above, the conventional image editing method requires a long time for an operation. Also, a shape of an image which is to be synthesized cannot be judged in an image editing window, and mistakes during an operation easily occur; therefore, operating efficiency is extremely bad.

### SUMMARY OF THE INVENTION

In view of the foregoing problems, it is an object of the present invention to provide an image editing method which solves the foregoing problems.

One feature of the present invention is an image editing method using a computer including a memory portion and a display portion connected to the computer, including a step in which first image data is read from the memory portion and displayed as a first image in an image editing window displayed in the display portion; a step in which second image data to be synthesized is displayed as an icon in the image editing window with respect to the first image; and a step in which after the icon is selected by an icon selecting means in the image editing window, the icon is displayed as a second image to synthesize the first image and the second image.

Another feature of the present invention is an image editing method using a computer including a memory portion and a display portion connected to the computer, including a step in which first image data is read from the memory portion and displayed as a first image in an image editing window displayed in the display portion; a step in which a file name or a folder of second image data to be synthesized is selected with respect to the first image displayed in the image editing window; a step in which the second image data is displayed as an icon in the image editing window; and a step in which after the icon is selected by an icon selecting means in the image editing window, the icon is displayed as a second image to synthesize the first image and the second image.

Furthermore, another feature of the present invention is an image editing method using a computer including a memory portion and a display portion connected to the computer, including a step in which an image displayed in an image editing window displayed in a display portion is divided into a first image and a second image; a step in which the second image displayed in the image editing window is iconified to be displayed in the image editing window; and a step in which an icon displayed in the image editing window after being iconified is selected by an icon selecting means to be stored in the memory portion.

A first image and a second image of the present invention may include character information.

An icon of the present invention may be a reduced second image.

Also, an icon of the present invention may be iconified at a random position in an image editing window.

In addition, an icon of the present invention may display a file name of a second image in an image editing window.

An icon selecting means of the present invention may be a cursor displayed in a display portion.

A cursor of the present invention may be operated by a mouse or a keyboard connected to a computer.

The present invention enables operation time to be shortened by iconifying an image included in another folder to display in an image editing window, in a case of synthesizing an image which is being edited and the image included in another folder.

In addition, in the present invention, a shape of image information can be judged by iconifying an image included in another folder; therefore, mistakes during an operation can be reduced.

### BRIEF DESCRIPTION OF THE DRAWINGS

In the accompanying drawings:

FIG. 1 is a block diagram of the present invention;

FIGS. 2A to 2F are explanatory diagrams of an image editing method of the present invention;

FIG. 3 is a flow chart of the present invention;

FIG. 4 is a conventional block diagram;

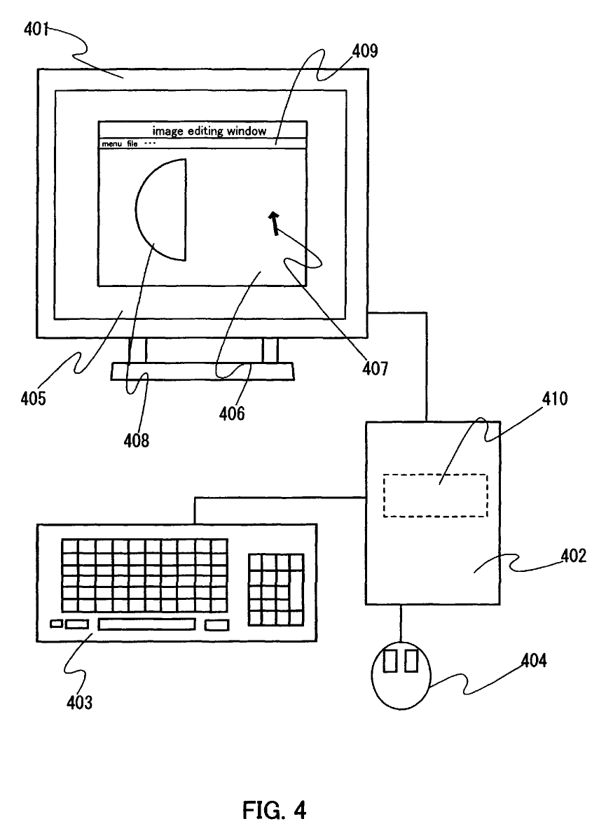

FIGS. 5A to 5D are explanatory diagrams of a conventional image editing method;

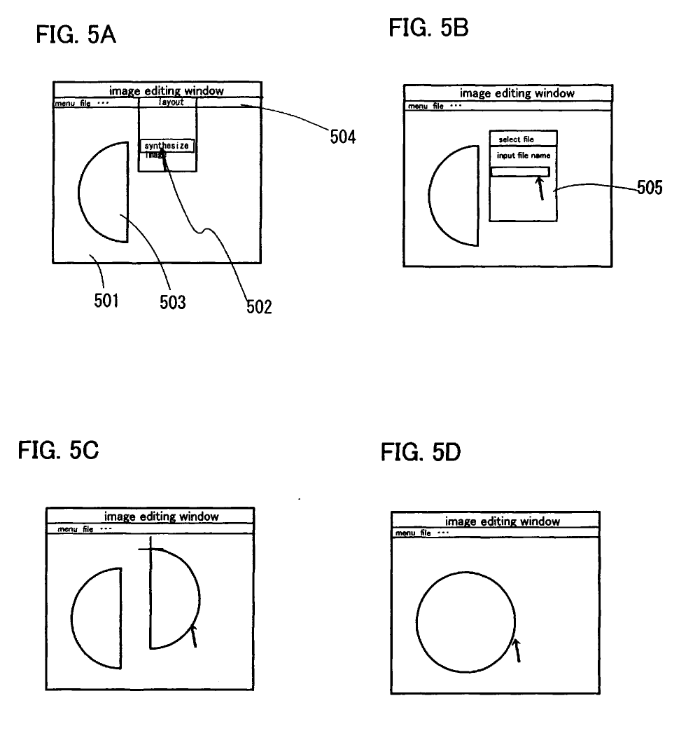

FIG. 6 is a conventional flow chart;

FIGS. 7A to 7F are explanatory diagrams of an image editing method of Embodiment Mode 2; and

FIG. 8 is a flow chart of Embodiment Mode 2.

### DETAILED DESCRIPTION OF THE INVENTION

Hereinafter, embodiment modes of the present invention will be described with reference to the accompanying drawings. However, the present invention can be carried out in many different modes, and it is easily understood by those skilled in the art that modes and details can be modified in various ways without departing from the purpose and the scope of the present invention. Therefore, the present invention should not be understood as being limited to the descriptions of the embodiment modes. Note that in the drawings hereinafter shown, the same reference numerals are used for the same portions or the portions having similar functions, and the repeated descriptions thereof are omitted.

Note that, in the present specification and the present invention, iconification means that an image used for editing is displayed in a window for editing an image as a reduced image; a deformed image; or a symbolized image. Also, in the present invention, icon means a figure displayed in a window for editing an image as a reduced image; a deformed image; or a symbolized image. An image used for editing to be edited is displayed in the window by selecting the icon using a mouse or the like.

Further, in the present specification and the present invention, image means a two dimensional figure displayed in an image editing window displayed in a display portion. In a case where a plurality of images is displayed in an image editing window, the images are referred to as a first image and a second image.

### Embodiment Mode 1

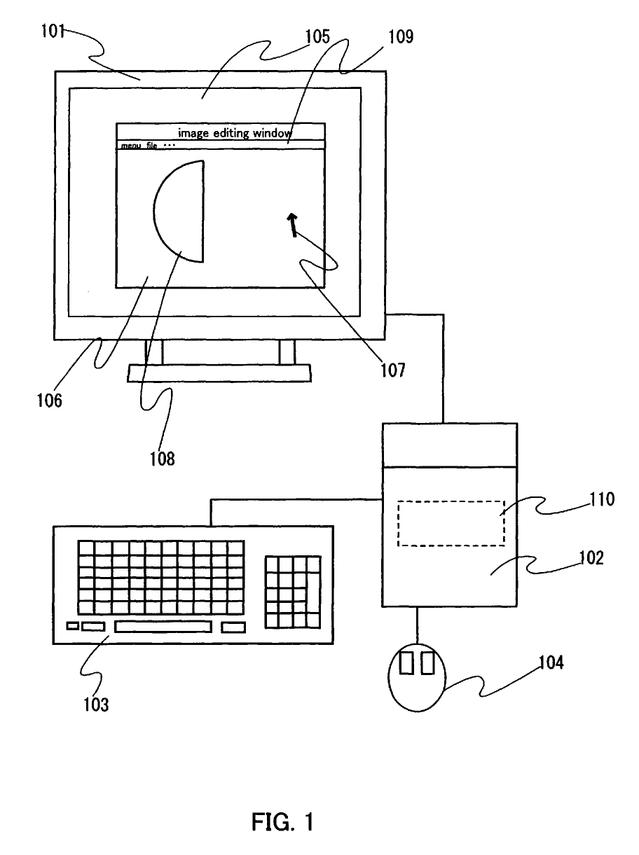

An embodiment mode of the present invention will be described in detail. FIG. 1 is a view showing a pattern diagram of computer peripheral equipment and an operation screen.

FIG. 1 shows a display housing 101, a computer 102, a keyboard 103, and a mouse 104. The computer 102 is connected to the display housing 101, the mouse 104 and the keyboard 103. The display housing 101 includes a display portion 105, in which an image editing window (also referred to as a work area, an editing screen, or a window) 106, a mouse cursor 107 (also simply referred to as a cursor), a two dimensional figure (referred to as an image or an object) 108, and a toolbar 109 are displayed. Also, a memory portion 110 for storing image information or the like is included inside the computer 102.

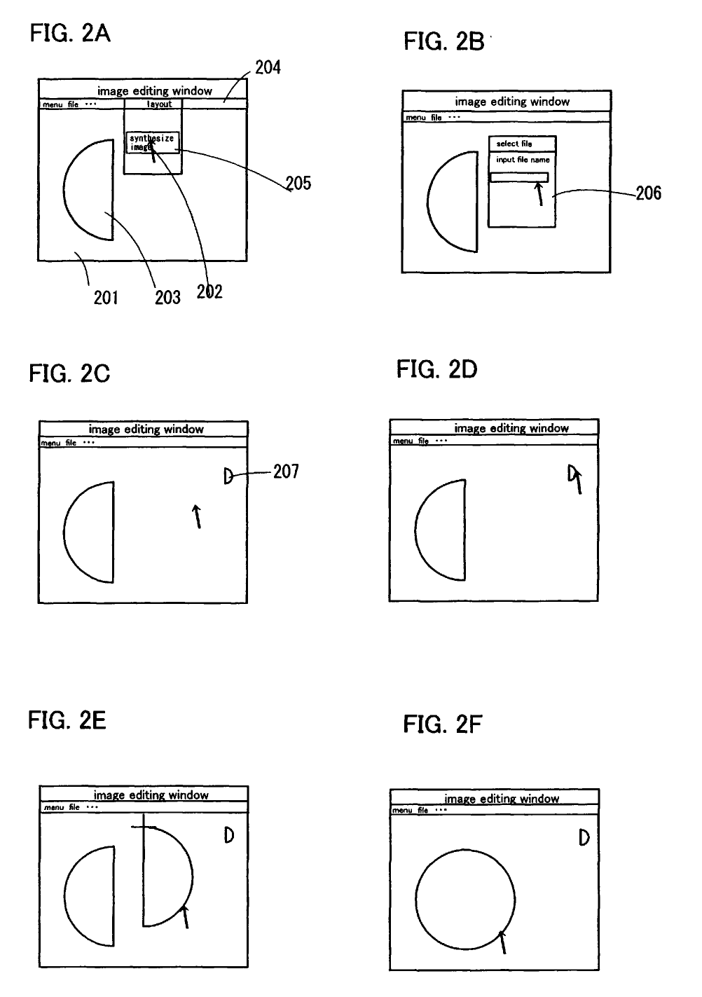

FIGS. 2A to 2F sequentially describe a method for synthesizing an image in the image editing window 106 of the display portion 105 in FIG. 1. FIGS. 2A to 2F show an image editing window 201, a mouse cursor 202, a two dimensional figure (first image) 203, a toolbar 204, and a command window 205.

Hereinafter, an image editing method of the present invention will be described in detail with reference to FIGS. 2A to 2F.

First, in FIG. 2A, in a case where the first image which is being edited in the image editing window and a second image included in another folder are synthesized, the toolbar 204 is selected by using the mouse or the keyboard. A command for synthesizing or reading the image is selected in the selected toolbar.

Subsequently, in FIG. 2B, an address or a name of a part which is to be synthesized is inputted to or selected by using an anew displayed sub-window 206 which selects data of a second image which is to be synthesized, by using the keyboard 103 or the mouse 104.

Subsequently, in FIG. 2C, an icon 207 of a second image which is to be synthesized is displayed. A read image is automatically iconified. A user (operator) can recognize the read image data as the second image by visibly recognizing the icon.

Further, the read second image data may be displayed as the second image in the image editing window of the display portion concurrently with being iconified in the image editing window. By automatically displaying the second image data as the second image in the image editing window concurrently with iconifying, selecting the icon again to display the second image is unnecessary; therefore, a user can shorten operation time for an image editing, which is preferable.

Further, a size of an icon of the second image may be set depending on amount of image data. For example, as for an image having high definition representation, its size may be set larger than that of a normal icon, and the size of the icon may be set in advance in accordance with a setting by a user, depending on an image to be synthesiezed. By iconifying a high definition image as a large icon, visibility is favorable and an image before being iconified can be judged at one view, which is preferable.

Subsequently, as for an image which is to be synthesized, as shown in FIG. 2D, the second image is displayed in the image editing window by selecting an icon of the image which is to be synthesized by using the mouse cursor 202. At this time, a display size of the second image to be synthesized is adjusted by the user in advance in accordance with an image size of the first image displayed in the image editing window; therefore, a user can shorten operation time for an image editing.

Subsequently, as shown in FIG. 2E, the second image to be synthesized is selected and moved to a random position in the image editing window in which the first image is displayed, by using the mouse cursor. Consequently, the synthesis of the first image and the second image is completed.

By iconifying an image for synthesizing in advance, as in the present invention, a user does not have to go back to the operation shown in FIG. 2A at the time of selecting the same second image again. At the time of selecting the same second image again, a user selects an objective icon in the image editing window and edits by using the second image again. Consequently, an objective can be accomplished.

Further, in this embodiment mode, a mouse cursor is shown as a means to select an icon and a mouse is shown as a means to operate the mouse cursor, as an example; however, the present invention is not limited thereto. In this embodiment mode, a mouse cursor which is a means to select an icon may be simply referred to as a cursor, and a keyboard, a controller, or another cursor operating means may also be used as a means to operate the cursor. In a case of using a pen tablet system for a personal information terminal such as PDA, an icon may be selected directly by a pen without through the cursor.

A plurality of images used for an image editing in an image editing window may be iconified in the image editing window. A plurality of images are iconified, and an icon of the image which is used by a user for an image editing is selected appropriately depending on the situation. Accordingly, operation time for an image editing can be shortened, which is preferable.

An icon of the present invention may be iconified at a random position which is specified by a user in an image editing window to be displayed. In addition, an icon may also be automatically iconified in part of an image editing window.

Also, a shape of an icon is not limited to the shape exemplified in this embodiment mode.

In the present invention, in addition to an image, a file name of image data to be synthesized may be displayed as character data in part of an icon concurrently with iconifying. By displaying the file name of image data concurrently with iconifying, a similar image can be prevented from being recognized wrongly among image data to be synthesized, which is preferable.

Also, any icon of an image for synthesizing of the present invention is acceptable as long as the icon is the reduced image data. By using the icon in which the image is reduced, the image can be edited without being recognized wrongly when the image is edited by a user. The image may be reduced by performing sampling with reduced sampling frequency. That is, a pixel of the image to be displayed may be thinned to perform a display. For example, in a case where an image is reduced to 1/n by iconification and displayed the reduced image, the reduced image may be displayed by reading image data corresponding to pixels, in which the reduced image is to be displayed from a memory portion at the same speed as image data corresponding to another pixels, in which an image other than the reduced image is to be displayed, and performing sampling only the image data corresponding to the pixels, in which the reduced image is to be displayed in driver circuit in every n pixels. In addition, an image of an icon may be stored in a computer based on the image to be displayed.

Also, in an image editing method of the present invention, the first image and the second image may include moving picture information. In addition, the first image and the second image may also include character information.

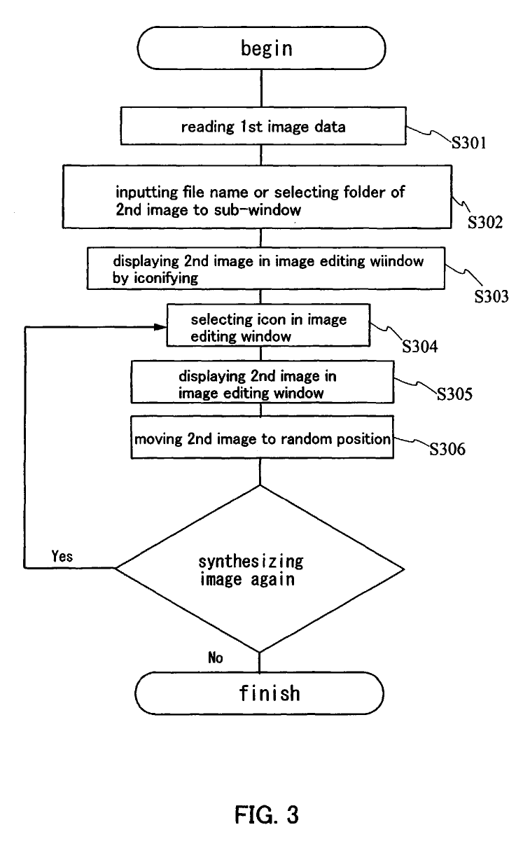

FIG. 3 shows a flow chart of an image editing method of the present invention. In a step S301 in FIG. 3, a computer reads image data of a first image from a memory portion (FIG. 2A). In a step S302 in FIG. 3, a file name of a second image for synthesizing is inputted or a folder is selected in a displayed sub-window (FIG. 2B). In a step S303 in FIG. 3, the second image to be synthesized is iconified in an image editing window to be displayed (FIG. 2C). In a step S304 in FIG. 3, a displayed icon is selected by a mouse pointer displayed in a display portion in the image editing window (FIG. 2D). In a step S305 in FIG. 3, the second image for synthesizing is displayed in the image editing window. Thereafter, in a step S306 in FIG. 3, the first image and the second image displayed in the image editing window are moved to a random position in the image editing window for synthesizing an image, by the mouse pointer which is operated by operating a mouse (FIG. 2E). Consequently, the image editing is performed (FIG. 2F).

Furthermore, when synthesized first image and second image are edited again by selecting image data of the second image, the image can be continuously edited by selecting the icon displayed in the image editing window. It is needless to say that, in a case where an image which is different from the second image is synthesized in the image editing window, the first image and the second image can be edited by selecting another icon displayed in the image editing window.

An image editing method of the present invention is useful especially when a plurality of images for editing are iconified in an image editing window, and image data to be edited is read by selecting an icon corresponding to an image for editing among a plurality of icons. By visibly recognizing the icon, a similar folder name is prevented from being recognized wrongly and mistakes during an operation can be attempted to be reduced.

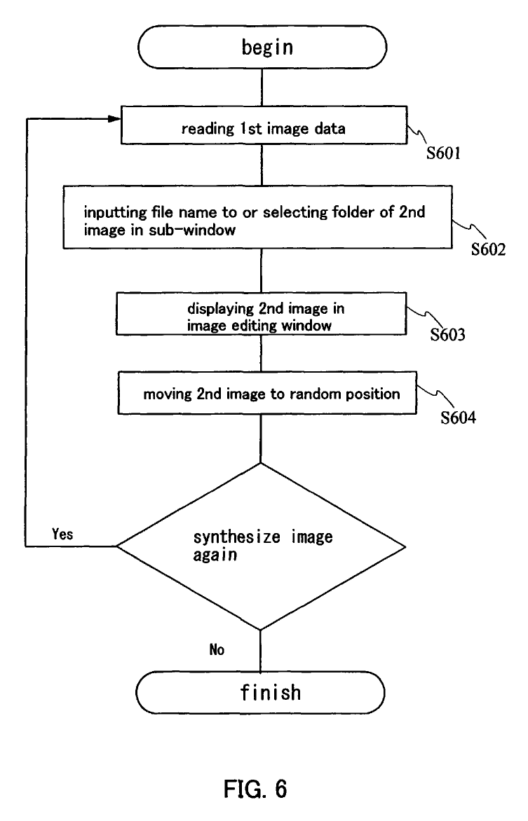

In the past, as shown in FIG. 6, when a second image is synthesized again, it was necessary to read image data from a sub-window. However, according to an image editing method of the present invention in this embodiment mode, by iconifying an image is to be synthesized with a shape of the image itself in the image editing window 106, image data can be read therefrom and the image can be edited. Consequently, a user can realize increase in operating efficiency and reduction in mistakes during an operation.

### Embodiment Mode 2

Another embodiment mode of the present invention will be described in detail. As for an image editing method of the present invention, a method, by which efficiency in an image editing is increased by iconifying an image which is divided by processing an image which is already displayed and saving to read the image at the time of editing the image again, will be described in detail.

Computer peripheral equipment outside an image editing window and an operation screen in an image editing method in this embodiment mode are similar to FIG. 1; therefore, the description thereof is omitted here. If necessary in this embodiment mode, the description of FIG. 1 is used.

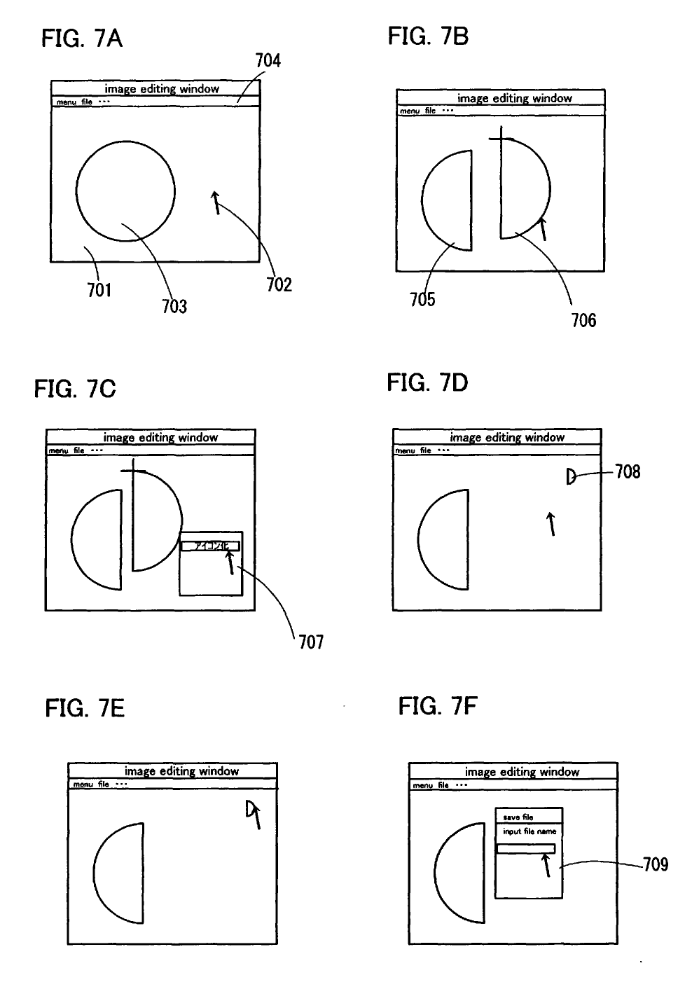

FIGS. 7A to 7F subsequently describe a method for dividing an image to be iconified in an image editing window 106 of a display portion 105 in FIG. 1. FIGS. 7A to 7F show an image editing window 701; a mouse cursor 702; a two dimensional figure (object) 703; and a toolbar 704.

Hereinafter, an image editing method of the present invention will be described in detail with reference to FIGS. 7A to 7F.

First, in FIG. 7A, the two dimensional figure (object) 703 in the image editing window is divided into a first image 705 and a second image 706 to be processed as shown in FIG. 7B by the mouse cursor or the like. It is needless to say that the two dimensional figure (object) may be further divided into a plurality of images. The two dimensional figure (object) may also be divided to be processed after being enlarged or reduced. In addition, the two dimensional figure (object) may also be divided to be processed after synthesizing another image with respect to the two dimensional figure (object).

In FIG. 7C, the second image which is to be iconified is selected, and iconification is selected in a sub-window 707. Thereafter, as shown in FIG. 7D, the second image 706 is iconified to be displayed as an icon in the image editing window.

Further, a size of an icon of the second image may be set depending on amount of image data. For example, as for an image having high definition representation, its size may be set larger than that of a normal icon, and the size of the icon may be set in advance in accordance with a setting by a user, depending on an image to be synthesized. By iconifying a high definition image as a large icon, visibility is favorable and an image before being iconified can be judged at one view, which is preferable.

As shown in FIG. 7E, an icon 708 is selected by the mouse cursor 702, and as shown in FIG. 7F, a sub-window 709 to which a file name is inputted is displayed in order to save the icon.

As in this embodiment mode, it is unnecessary for a user (operator) to read the same image data to select again by iconifying an image in which a two dimensional figure (object) is divided. A user can display an image in an image editing window and edit the image by selecting an icon.

In addition, iconifying an image as in this embodiment mode is useful especially when a plurality of images is developed to be edited in an image editing window. By iconifying, favorable visibility can be obtained. Also, in the image editing window, a space for displaying an image is reduced, and operating efficiency of an image editing or the like can be expected.

Further, in this embodiment mode, a mouse cursor is shown as a means to select an icon and a mouse is shown as a means to operate the mouse cursor, as an example; however, the present invention is not limited thereto. In this embodiment mode, a mouse cursor which is a means to select an icon may be simply referred to as a cursor, and a keyboard, a controller, or another cursor operating means may also be used as a means to operate the cursor. In a case of using a pen tablet system for individual a personal terminal such as PDA, an icon may be selected.

A plurality of images used for an image editing in an image editing window may be iconified in the image editing window. A plurality of images is iconified, and image data which is used by a user for an image editing is selected appropriately depending on the situation. Accordingly, operation time for an image editing can be shortened, which is preferable.

An icon of the present invention may be iconified and displayed at a random position which is specified by a user in an image editing window to be displayed. In addition, an icon may also be automatically iconified in part of an image editing window.

Also, a shape of an icon is not limited to the shape exemplified in this embodiment mode.

In the present invention, in addition to an image, a file name of image data to be synthesized may be inputted to be displayed as character data in part of an icon concurrently with iconifying. By displaying the file name of image data concurrently with iconifying, a similar image can be prevented from being recognized wrongly, which is preferable.

Also, any icon of an image for synthesizing of the present invention is acceptable as long as the icon is the reduced image data. By using the icon in which the image is reduced, the image can be edited without being recognized wrongly when the image is edited by a user. The image may be reduced by performing sampling with reduced frequency. That is, a pixel of the image to be displayed may be thinned to perform a display. For example, in a case where an image is reduced to 1/n by iconification to be displayed, the reduced image may be displayed by reading image data corresponding to pixels in which the reduced image is displayed from a memory portion at the same speed as image data corresponding to another pixels in which an image other than the reduced image is displayed, and performing sampling to the image data corresponding to the pixels in which the reduced image is displayed in driver circuit in every n pixel. In addition, an image of an icon may be stored in a computer based on the image to be displayed.

Also, in an image editing method of the present invention, the first image and the second image may include moving picture information. In addition, the first image and the second image may also include character information.

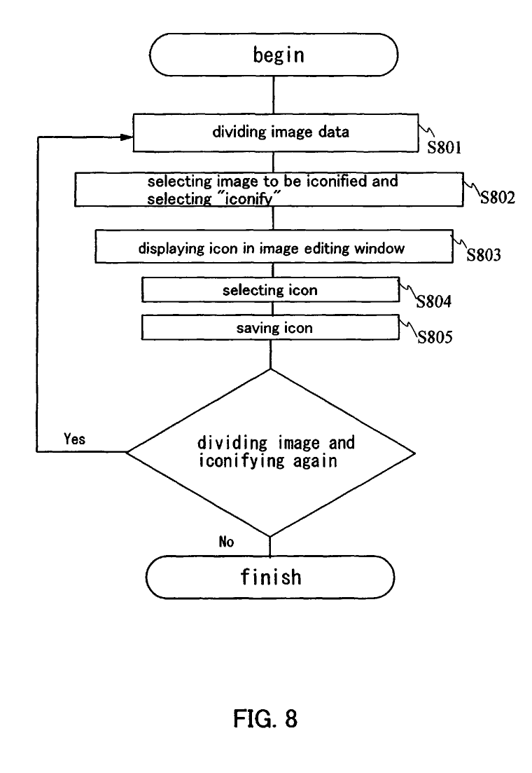

In FIG. 8, a flow chart of an image editing method of the present invention is shown. In a step S801 in FIG. 8, an image displayed in an image editing window is divided (FIGS. 7A and 7B). In a step S802 in FIG. 8, an image which is to be iconified is selected, and a command of “iconification” is selected in a displayed sub-window (FIG. 7C). In a step S803 in FIG. 8, an icon in which the image is iconified is displayed in the image editing window. In a step S804 in FIG. 8, the icon displayed in the image editing window is selected (FIG. 7D and 7E). Thereafter, in a step S805 in FIG. 8, the icon displayed in the image editing window is selected and the icon is saved (FIG. 7F).

Furthermore, when the image is divided again to be iconified, a first image or another image which is displayed in the image editing window is selected; accordingly, the image can be iconified. It is needless to say that, in a case where another image is edited in the image editing window during this time, another icon which is displayed in the image editing window is selected and the image can be edited.

An image editing method of the present invention is useful especially when a plurality of images for editing is iconified to be displayed in an image editing window, and image data to be edited is read by selecting an icon corresponding to an image for editing among a plurality of icons. By visibly recognizing the icon, a similar folder name is prevented from being recognized wrongly and mistakes during an operation can be attempted to be reduced.

Also, this embodiment mode can be freely combined with any descriptions of the above embodiment mode.

This application is based on Japanese Patent Application serial No. 2005-133386 filed in Japan Patent Office on Apr., 28 in 2005, the entire contents of which are hereby incorporated by reference.

What is claimed is:

1. A method for editing an image, using a computer including a memory portion and a display portion connected to the computer, comprising the steps of:
reading first image data from the memory portion;
displaying the first image data as a first image in an image editing window displayed in the display portion;
displaying second image data as an icon in the image editing window;
displaying the icon as a second image after the icon is selected by an icon selecting means in the image editing window; and
synthesizing the first image and the second image.

2. A method for editing an image, using a computer including a memory portion and a display portion connected to the computer, comprising the steps of:
reading first image data from the memory portion
displaying the first image data as a first image in an image editing window displayed in the display portion;
selecting a file name or a folder of second image data;
displaying the second image data as an icon in the image editing window; and
displaying the icon as a second image after the icon is selected by an icon selecting means in the image editing window; and
synthesizing the first image and the second image.

3. A method for editing an image, using a computer including a memory portion and a display portion connected to the computer, comprising the steps of:
dividing an image which is displayed in an image editing window displayed in the display portion into a first image and a second image;
displaying an icon in the image editing window by iconifiying the second image;
selecting the icon displayed in the image editing window by an icon selecting means; and
storing the icon in the memory portion.

4. A method for editing an image according to claim 1, wherein the first image and the second image include character information.

5. A method for editing an image according to claim 2, wherein the first image and the second image include character information.

6. A method for editing an image according to claim 3, wherein the first image and the second image include character information.

7. A method for editing an image according to claim 1, wherein the icon is the reduced second image.

8. A method for editing an image according to claim 2, wherein the icon is the reduced second image.

9. A method for editing an image according to claim 3, wherein the icon is the reduced second image.

10. A method for editing an image according to claim 1, wherein the icon is iconified at a random position of the image editing window.

11. A method for editing an image according to claim 2, wherein the icon is iconified at a random position of the image editing window.

12. A method for editing an image according to claim 3, wherein the icon is iconified at a random position of the image editing window.

13. A method for editing an image according to claim 1, wherein a file name of the second image is displayed by the icon in the image editing window.

14. A method for editing an image according to claim 2, wherein a file name of the second image is displayed by the icon in the image editing window.

15. A method for editing an image according to claim 3, wherein a file name of the second image is displayed by the icon in the image editing window.

16. A method for editing an image according to claim 1, wherein the icon selecting means is a cursor which is displayed in the display portion.

17. A method for editing an image according to claim 2, wherein the icon selecting means is a cursor which is displayed in the display portion.

18. A method for editing an image according to claim 3, wherein the icon selecting means is a cursor which is displayed in the display portion.

19. A method for editing an image according to claim 16, wherein the cursor is operated by a mouse connected to the computer, or a keyboard.

20. A method for editing an image according to claim 17, wherein the cursor is operated by a mouse connected to the computer, or a keyboard.

21. A method for editing an image according to claim 18, wherein the cursor is operated by a mouse connected to the computer, or a keyboard.
